(19) United States
(12) Patent Application Publication
(10) Pub. No.: US 2024/0124022 A1
(43) Pub. Date: Apr. 18, 2024

(54) Increasing a Degree of Automation of a Driver Assistance System of a Motor Vehicle

(71) Applicant: Bayerische Motoren Werke Aktiengesellschaft, Muenchen (DE)

(72) Inventors: Luca PAROLINI, Landshut (DE); Sebastian SCHNEIDER, Feldkirchen (DE)

(21) Appl. No.: 18/277,609

(22) PCT Filed: Jan. 19, 2022
(86) PCT No.: PCT/EP2022/051057

§ 371 Date: Aug. 17, 2023

(30) Foreign Application Priority Data
Feb. 23, 2021 (DE) 10 2021 104 220.8

(51) Int. Cl. B60W 60/00; B60W 40/04

(52) U.S. Cl. CPC B60W 60/0015; B60W 40/04; B60W 2552/00; B60W 2554/40

(57) ABSTRACT

Please substitute the new Abstract submitted herewith for the original Abstract: A system for increasing a degree of automation of a driver assistance system of a motor vehicle by using at least a second sensor and/or at least a second computing unit of a traffic participant in the surroundings of the motor vehicle is provided.

### BACKGROUND AND SUMMARY OF THE INVENTION

The invention relates to a system and a method for increasing a degree of automation of a driver assistance system of a motor vehicle.

The term “automated driving” can be understood in the scope of this document as driving having automated longitudinal or lateral control or autonomous driving having automated longitudinal and lateral control. The term “automated driving” comprises automated driving with an arbitrary degree of automation. Exemplary degrees of automation are assisted, partially automated, highly automated, or fully automated driving. These degrees of automation were defined by the Bundesanstalt für StraBenwesen [German Federal Highway Research Institute] (BASt). In assisted driving, the driver continuously executes the longitudinal or lateral control, while the system takes over the respective other function in certain limits. In partially automated driving (TAF), the system takes over the longitudinal and lateral control for a certain period of time and/or in specific situations, wherein the driver has to continuously monitor the system as in assisted driving. In highly automated driving (HAF), the system takes over the longitudinal and lateral control for a certain period of time without the driver having to continuously monitor the system; however, the driver has to be capable of taking over the vehicle control in a certain time. In fully automated driving (VAF), the system can automatically manage the driving in all situations for a specific application; a driver is no longer necessary for this application. The above-mentioned four degrees of automation according to the definition of the BASt correspond to the SAE levels 1 to 4 of the norm SAE (SAE—Society of Automotive Engineering). For example, highly automated driving (HAF) corresponds according to the BASt to level 3 of the SAE. Furthermore, SAE level 5 is also provided as the highest degree of automation in SAE, which is not included in the definition of the BASt. SAE level 5 corresponds to driverless driving, in which the system can automatically manage all situations like a human driver during the entire journey; a driver is generally no longer required.

With an increasing level of automation, the requirements for hardware and software of the motor vehicle also increase, which results in higher production costs of the motor vehicle.

It is an object of the invention to enable higher levels of automation without higher production costs of the motor vehicle.

The object is achieved by the features of the independent claims. Advantageous embodiments are described in the dependent claims. It is to be noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

A first aspect of the invention relates to a system for increasing a degree of automation of a driver assistance system of a motor vehicle.

The driver assistance system comprises at least one first sensor, at least one first computing unit, and at least one actuator as components, wherein the at least one first sensor, the at least one first computing unit, and the at least one actuator are component parts of the motor vehicle.

The at least one first sensor is in particular a sensor for surroundings detection, for example, a radar, camera, lidar, or ultrasonic sensor.

The at least one actuator is, for example, a steering system or a drive of the motor vehicle.

The system also comprises, in addition to the components of the motor vehicle, thus the driver assistance system, the at least one first sensor, the at least one first computing unit, and the at least one actuator, components of a road user in the surroundings of the motor vehicle. The system is thus in particular a dynamic system, which comprises various components on the basis of an ad hoc network in the progress over time of the operation. For example, the ad hoc network is formed here via mobile wireless or WLAN.

The degree of automation of the driver assistance system places safety requirements on the at least one sensor, the at least one computing unit, and the at least one actuator, wherein a higher degree of automation places higher requirements than a lower degree of automation.

These safety requirements are typically derived during the development of the driver assistance system. For this purpose, a procedure is known in the prior art in the standard ISO 26262, in which hazardous faults of the system are ascertained by means of a hazard and risk analysis. Safety concepts are then created to handle the hazardous faults, from which functional and nonfunctional requirements for the components of the system result.

The components of the driver assistance system are configured to meet safety requirements up to a specified degree, by which the degree of automation to be reached by the driver assistance system is limited.

The highest degree of safety requirements achievable by the components of the driver assistance system can be manually ascertained, for example, during the development of the driver assistance system. However, methods are also already known in the prior art, in which formalized safety requirements are compared in an automated manner at the runtime of the system with formalized properties of the component, so that the highest achievable degree of safety requirements can also be determined in an automated manner at the runtime of the system.

The system is configured to identify a road user in the surroundings of the motor vehicle, for example, a further motor vehicle. The identification can take place, for example, by means of the sensors of the motor vehicle and/or via a wireless network, which can possibly be used directly as the basis for an ad hoc network communication.

Moreover, the system is configured to establish that the road user comprises at least one second sensor and/or at least one second computing unit. The second sensor is in particular a sensor for surroundings detection, for example, a radar, camera, lidar, or ultrasonic sensor.

In addition, the system is configured to check whether the driver assistance system meets the safety requirements of the higher degree of automation upon use of the at least one second sensor and/or the at least one second computing unit.

In particular, the system is configured to compare the formalized safety requirements of the higher degree of automation with formalized properties of the at least one first sensor, the at least one first computing unit, the at least one actuator, the at least one second sensor, and the at least one second computing unit, in order to check whether the driver assistance system meets the safety requirements of the higher degree of automation upon use of the at least one second sensor and/or the at least one second computing unit. For this purpose, for example, the approach of so-called “safety contracts” known in the prior art can be used.

Moreover, the system is configured to increase the degree of automation, using which the driver assistance system controls the motor vehicle, to the higher degree of automation by using the at least one second sensor and/or the at least one second computing unit, if the driver assistance system meets the safety requirements of the higher degree of automation upon use of the at least one second sensor and/or the at least one second computing unit.

Alternatively, increasing the degree of automation, using which the driver assistance system controls the motor vehicle, can also only be offered to the driver of the motor vehicle, so that the decision about the actual degree of automation remains with the driver of the motor vehicle.

In one advantageous embodiment of the invention, a driver assistance system of the road user comprises the at least one second sensor and/or the at least one second computing unit.

The driver assistance system of the road user is configured to control the road user in an automated manner. In particular, the driver assistance system of the road user is configured to control the longitudinal and/or lateral control of the road user.

The system is configured to specify to the driver assistance system of the road user to control the road user in an automated manner in such a way that the driver assistance system of the motor vehicle can use the at least one second sensor and/or the at least one second computing unit. In particular, the system is configured to specify a trajectory to the driver assistance system of the road user, along which the driver assistance system of the road user is to guide the road user.

The driver assistance system of the motor vehicle can in particular use the at least one second sensor when the sensor range detected by the at least one second sensor is in the surroundings of the motor vehicle. For example, the driver assistance system of the motor vehicle can use the at least one second sensor when the sensor range detected by the at least one second sensor at least partially overlaps with the sensor range detected by the at least one first sensor.

In a further advantageous embodiment of the invention, the system is configured to decompose the safety requirements of the higher degree of automation to the at least one first sensor, the at least one second sensor, the at least one first computing unit, and/or the at least one second computing unit. The fundamental set of rules for decomposition of safety requirements is described in volume 9 of ISO 26262. The automation of decomposition is also known in the prior art.

The system is additionally configured to check whether the driver assistance meets the safety requirements of the increased degree of automation upon additional use of the at least one second sensor and/or the at least one second computing unit, and to increase the degree of automation of the motor vehicle to the increased degree of automation by using the at least one second sensor and/or the at least one second computing unit if the driver assistance system meets the safety requirements of the increased degree of automation upon additional use of the at least one second sensor and/or the at least one second computing unit.

In a further advantageous embodiment of the invention, the road user comprises at least one second computing unit, and the driver assistance system of the motor vehicle is configured to use the at least one second computing unit as a redundant computing path to a computing path on the at least one first computing unit.

In a further advantageous embodiment of the invention, the road user comprises at least one second sensor, and the driver assistance system of the motor vehicle is configured to use the at least one second sensor as a sensor diverse from the at least one first sensor.

In particular, the driver assistance system of the motor vehicle is configured to use the at least one second sensor as a sensor diverse from the at least one first sensor if the sensor ranges of the at least one first sensor and the at least one second sensor at least partially overlap and the sensor principles of the at least one first sensor and the at least one second sensor differ. The sensor principle of a sensor is the physical mode of operation of the sensor. Different sensor principles are, for example, radar, lidar, camera, or ultrasound.

In a further advantageous embodiment of the invention, the road user comprises at least one second sensor and the driver assistance system of the motor vehicle is configured to use the at least one second sensor as an additional perspective of the surroundings of the motor vehicle.

In particular, the driver assistance system of the motor vehicle is configured to use the at least one second sensor as an additional perspective of the surroundings of the motor vehicle if the sensor range of the at least one first sensor and the sensor range of the at least one second sensor at least partially overlap. Due to the different positions of the at least one first sensor and the at least one second sensor, which result due to their attachment to the motor vehicle and the road user, an additional perspective of the surroundings of the motor vehicle results.

In particular, the driver assistance system of the motor vehicle is configured to use the at least one second sensor as an additional perspective of the surroundings of the motor vehicle if the sensor range of the at least one first sensor and the sensor range of the at least one second sensor do not overlap, for example, if the sensor range of the at least one second sensor covers a part of the surroundings of the motor vehicle which is not detected by the sensor range of the at least one first sensor. Thus, for example, a front sensor of the road user can be used as the at least one second sensor if the road user is located in front of the vehicle. It is therefore possible, for example, to react faster to emergency situations, since the motor vehicle does not first identify a reaction of the road user, but rather can already independently evaluate the front sensor of the road user and, for example, can increase the distance of the motor vehicle from the road user, can reduce the velocity of the motor vehicle, and/or can activate hazard lights.

In a further advantageous embodiment of the invention, the system is configured to identify the road user in the surroundings of the motor vehicle in a congestion situation. A congestion situation is a traffic situation having traffic which is very halting or has come to a standstill. A congestion situation is in particular when multiple vehicles are at less than 20 km/h for at least five minutes long on average and this occurs on a length of at least one kilometer. Alternatively or additionally, a congestion situation is also, for example, when multiple vehicles drive at between 20 and 40 km/h for at least five minutes long on average and this occurs on the length of at least one kilometer.

The invention is based on the finding in this case that in the congestion situation, the road user will be located for a relatively long time in the surroundings of the motor vehicle and therefore the sensor ranges of the at least one first sensor and the at least one second sensor overlap for a comparatively long time. The invention can therefore be used for a particularly long time in a congestion situation, which avoids frequent changes of the degree of automation of the motor vehicle.

In a further advantageous embodiment of the invention, the road user is an object of the traffic infrastructure.

A second aspect of the invention relates to a method for increasing a degree of automation of a driver assistance system of a motor vehicle.

The driver assistance system comprises at least one first sensor, at least one first computing unit, and at least one actuator as components.

The degree of automation of the driver assistance system places safety requirements on the at least one sensor, the at least one computing unit, and the at least one actuator, wherein a higher degree of automation places higher requirements than a lower degree of automation.

The components of the driver assistance system are configured to meet safety requirements up to a specified degree, by which the degree of automation to be achieved by the driver assistance system is limited.

One step of the method is identifying a road user in the surroundings of the motor vehicle.

A further step of the method is establishing that the road user comprises at least one second sensor and/or at least one second computing unit.

A further step of the method is checking whether the driver assistance system meets the safety requirements of the higher degree of automation upon use of the at least one second sensor and/or the at least one second computing unit.

A further step of the method is increasing the degree of automation to the higher degree of automation by using the at least one second sensor and/or the at least one second computing unit if the driver assistance system meets the safety requirements of the higher degree of automation upon use of the at least one second sensor and/or the at least one second computing unit.

The above statements on the system according to the invention according to the first aspect of the invention also apply correspondingly to the method according to the invention according to the second aspect of the invention. Advantageous exemplary embodiments of the method according to the invention which are not explicitly described at this point and in the claims correspond to the advantageous exemplary embodiments of the system according to the invention described above or described in the claims.

The invention will be described hereinafter on the basis of an exemplary embodiment with the aid of the appended drawings. In the figures:

### BRIEF DESCRIPTION OF THE DRAWINGS

FIG. 1 shows an exemplary traffic situation in which the invention is usable,

FIG. 2 shows an exemplary embodiment of the invention,

FIG. 3 shows an illustration of the relationship between degree of automation, safety requirements, and components of the driver assistance system, and

FIG. 4 shows an illustration of the concept of the decomposition of safety requirements.

### DETAILED DESCRIPTION OF THE DRAWINGS

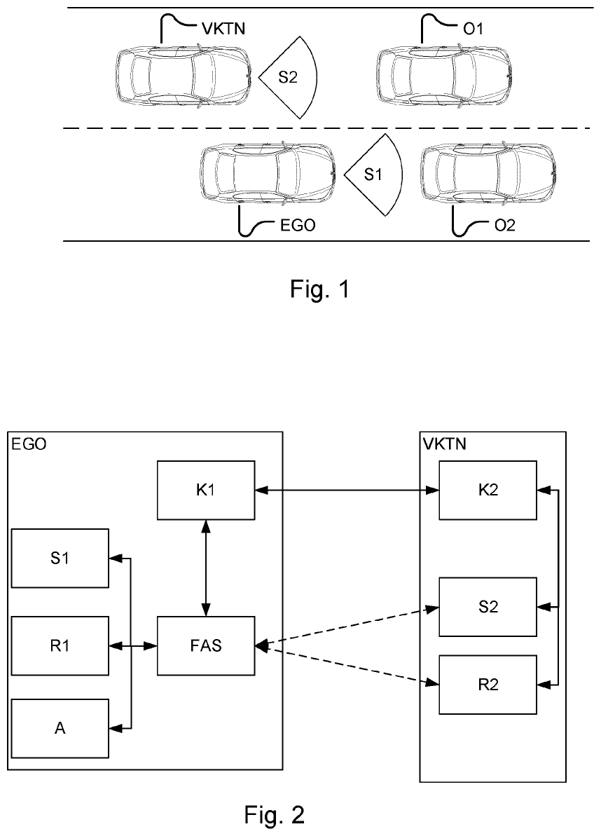

FIG. 1 shows an exemplary traffic situation, in which the invention is particularly advantageously usable.

This is a congestion situation. The system according to the invention is configured in particular to identify the road user VKTN in the surroundings of the motor vehicle EGO in a congestion situation.

The sensor ranges of the at least one first sensor S1 comprised by the motor vehicle EGO and the at least one second sensor S2 comprised by the road user VKTN at least partially overlap in this exemplary traffic situation. The two further road users O1, O2 are located in the sensor ranges of the at least one first sensor S1 and the at least one second sensor S2. The two further road users O1, O2 in the surroundings of the motor vehicle EGO can thus each be detected from different perspectives, which makes an error in the detection less probable than in the case of a detection exclusively by the at least one first sensor S1. Upon additional use of the at least one second sensor S2 by the driver assistance system of the motor vehicle EGO, the driver assistance system of the motor vehicle EGO can thus meet higher safety requirements A3 than without the additional use of the at least one second sensor S2. The driver assistance system of the motor vehicle EGO can therefore also reach a higher degree of automation L3.

FIG. 2 shows an exemplary embodiment of the system according to the invention for increasing a degree of automation of a driver assistance system of a motor vehicle EGO.

The driver assistance system comprises at least one first sensor S1, at least one first computing unit R1, and at least one actuator A as components. In addition, the driver assistance system comprises a control unit FAS and a communication unit K1.

The degree of automation L2, L3 of the driver assistance system places safety requirements A2, A3 on the at least one sensor S1, the at least one computing unit R1, and the at least one actuator A, wherein a higher degree of automation L3 places higher requirements A3 than a lower degree of automation L2.

The components of the driver assistance system are configured to meet safety requirements A2 up to a specified degree, by which the degree of automation L2 to be achieved by the driver assistance system is limited.

The system is configured to identify a road user VKTN in the surroundings of the motor vehicle EGO, and to establish that the road user VKTN comprises at least one second sensor S2 and/or at least one second computing unit R2. This can take place, for example, in that the communication unit K1 of the motor vehicle EGO forms an ad hoc network with a communication unit K2 of the road user VKTN.

In addition, the system is configured to check whether the driver assistance system meets the safety requirements A3 of the higher degree of automation L3 upon use of the at least one second sensor S2 and/or the at least one second computing unit R2. The at least one second sensor S2 and the at least one second computing unit R2 are virtually connected to the control unit FAS here, for example, so that this control unit can access the at least one first sensor S1, the at least one first computing unit R1, the at least one actuator A, the at least one second sensor S2, and the at least one second computing unit R2.

The system is furthermore configured to increase the degree of automation to the higher degree of automation L3 by using the at least one second sensor S2 and/or the at least one second computing unit R2 if the driver assistance system meets the safety requirements A3 of the higher degree of automation L3 upon use of the at least one second sensor S2 and/or the at least one second computing unit R2.

The system is configured in particular to decompose the safety requirements A3 of the higher degree of automation L3 onto the at least one first sensor S1, the at least one second sensor S2, the at least one first computing unit R1, and/or the at least one second computing unit R2, in order to check whether the driver assistance system meets the safety requirements A3 of the increased degree of automation L3 upon additional use of the at least one second sensor S2 and/or the at least one second computing unit R2, and to increase the degree of automation of the motor vehicle EGO to the increased degree of automation L3 by using the at least one second sensor S2 and/or the at least one second computing unit R2 if the driver assistance system meets the safety requirements A3 of the increased degree of automation L3 upon additional use of the at least one second sensor S2 and/or the at least one second computing unit R2.

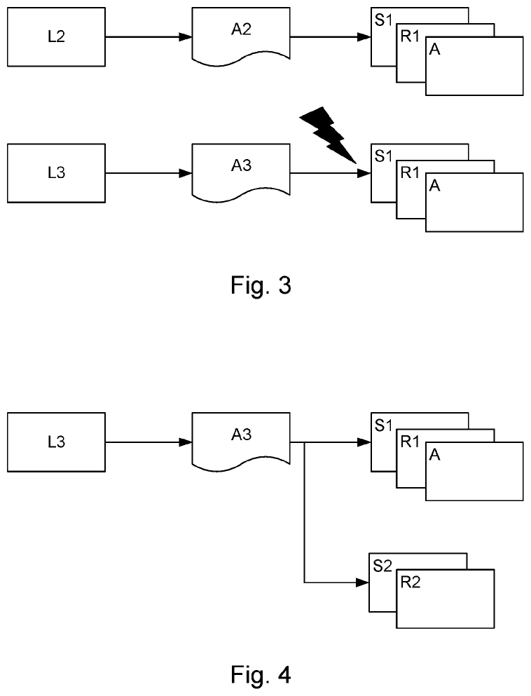

FIG. 3 shows an illustration of the relationship between degree of automation, safety requirements, and components of the driver assistance system.

For example, the degree of automation L2 places the safety requirements A2 on the components of the driver assistance system, thus on the at least one first sensor S1, the at least one first computing unit R1, and the at least one actuator A.

The degree of automation L3 places the safety requirements A3 on the components of the driver assistance system, thus on the at least one first sensor S1, the at least one first computing unit R1, and the at least one actuator A, wherein the higher degree of automation L3 places higher safety requirements A3 than the safety requirements A2 of the lower degree of automation L2.

In contrast to the lower safety requirements A2, the higher safety requirements A3 possibly cannot be met by the components of the driver assistance system, so that the driver assistance system can achieve at most the lower degree of automation L2.

FIG. 4 shows an illustration of the concept of the decomposition of safety requirements.

As already mentioned with respect to FIG. 3, the components of the driver assistance system, thus the at least one first sensor S1, the at least one computing unit R1, and the at least one actuator A possibly cannot meet the high safety requirements A3.

With the decomposition of safety requirements, ISO 26262 enables the level of the safety requirements, the so-called safety load, on components to be reduced if the safety load can be distributed onto additional components. Thus, for example, the components of the driver assistance system in conjunction with the additional components of the road user VKTN, thus the at least one second sensor S2 and the at least one second computing unit R2, certainly meet the higher safety requirements A3, so that the driver assistance system can achieve the higher degree of automation L3 upon use of the additional components of the road user.

1.-9. (canceled)

10. A system for increasing a degree of automation of a driver assistance system of a motor vehicle, wherein the driver assistance system includes at least one first sensor, at least one first computing unit, and at least one actuator as components,
the degree of automation of the driver assistance system places safety requirements on the at least one sensor, the at least one computing unit, and the at least one actuator, wherein a higher degree of automation places higher requirements than a lower degree of automation,
the components of the driver assistance system are configured to meet safety requirements up to a specified degree, by which the degree of automation to be achieved by the driver assistance system is limited,
the system is configured to:
identify a road user in the surroundings of the motor vehicle,
establish that the road user comprises at least one second sensor and/or at least one second computing unit,
check whether the driver assistance system meets the safety requirements of the higher degree of automation upon use of the at least one second sensor and/or the at least one second computing unit, and
increase the degree of automation to the higher degree of automation by using the at least one second sensor and/or the at least one second computing unit if the driver assistance system meets the safety requirements of the higher degree of automation upon use of the at least one second sensor and/or the at least one second computing unit.

11. The system according to claim 10, wherein
a driver assistance system of the road user comprises the at least one second sensor and/or the at least one second computing unit,
the driver assistance system of the road user is configured to control the road user in an automated manner, and
the system is configured to specify to the driver assistance system of the road user to control the road user in an automated manner such that the driver assistance system of the motor vehicle can use the at least one second sensor and/or the at least one second computing unit.

12. The system according to claim 10, wherein the system is configured to:
decompose the safety requirements of the higher degree of automation onto the at least one first sensor, the at least one second sensor, the at least one first computing unit, and/or the at least one second computing unit,
check whether the driver assistance system meets the safety requirements of the increased degree of automation upon additional use of the at least one second sensor and/or the at least one second computing unit, and
increase the degree of automation of the motor vehicle to the increased degree of automation by using the at least one second sensor and/or the at least one second computing unit if the driver assistance system meets the safety requirements of the increased degree of automation upon additional use of the at least one second sensor and/or the at least one second computing unit.

13. The system according to claim 11, wherein the system is configured to:
decompose the safety requirements of the higher degree of automation onto the at least one first sensor, the at least one second sensor, the at least one first computing unit, and/or the at least one second computing unit,
check whether the driver assistance system meets the safety requirements of the increased degree of automation upon additional use of the at least one second sensor and/or the at least one second computing unit, and
increase the degree of automation of the motor vehicle to the increased degree of automation by using the at least one second sensor and/or the at least one second computing unit if the driver assistance system meets the safety requirements of the increased degree of automation upon additional use of the at least one second sensor and/or the at least one second computing unit.

14. The system according to claim 10, wherein
the road user comprises at least one second computing unit, and
the driver assistance system of the motor vehicle is configured to use the at least one second computing unit as a redundant computing path to a computing path on the at least one first computing unit.

15. The system according to claim 11, wherein
the road user comprises at least one second computing unit, and
the driver assistance system of the motor vehicle is configured to use the at least one second computing unit as a redundant computing path to a computing path on the at least one first computing unit.

16. The system according to claim 10, wherein
the road user comprises at least one second sensor, and
the driver assistance system of the motor vehicle is configured to use the at least one second sensor as a sensor diverse from the at least one first sensor.

17. The system according to claim 11, wherein
the road user comprises at least one second sensor, and
the driver assistance system of the motor vehicle is configured to use the at least one second sensor as a sensor diverse from the at least one first sensor.

18. The system according to claim 10, wherein
the road user comprises at least one second sensor, and
the driver assistance system of the motor vehicle is configured to use the at least one second sensor as an additional perspective of the surroundings of the motor vehicle.

19. The system according to claim 11, wherein
the road user comprises at least one second sensor, and
the driver assistance system of the motor vehicle is configured to use the at least one second sensor as an additional perspective of the surroundings of the motor vehicle.

20. The system according to claim 10, wherein the system is configured to identify the road user in the surroundings of the motor vehicle in a congestion situation.

21. The system according to claim 11, wherein the system is configured to identify the road user in the surroundings of the motor vehicle in a congestion situation.

22. The system according to claim 10, wherein the road user is an object of the traffic infrastructure.

23. The system according to claim 11, wherein the road user is an object of the traffic infrastructure.

24. A method for increasing a degree of automation of a driver assistance system of a motor vehicle, wherein
the driver assistance system comprises at least one first sensor, at least one first computing unit, and at least one actuator as components,
the degree of automation of the driver assistance system places safety requirements on the at least one sensor, the at least one computing unit, and the at least one actuator, wherein a higher degree of automation places higher requirements than a lower degree of automation,
the components of the driver assistance system are configured to meet safety requirements up to a specified degree, by which the degree of automation to be achieved by the driver assistance system is limited,
the method comprising:
identifying a road user in the surroundings of the motor vehicle;
establishing that the road user comprises at least one second sensor and/or at least one second computing unit;
checking whether the driver assistance system meets the safety requirements of the higher degree of automation upon use of the at least one second sensor and/or the at least one second computing unit; and
increasing the degree of automation to the higher degree of automation by using the at least one second sensor and/or the at least one second computing unit if the driver assistance system meets the safety requirements of the higher degree of automation upon use of the at least one second sensor and/or the at least one second computing unit.
